(19) United States
(12) Patent Application Publication
(10) Pub. No.: US 2022/0391218 A1
(43) Pub. Date: Dec. 8, 2022

(54) AUTONOMOUS AGNOSTIC SMART SENSOR

(71) Applicant: XIDAS, INC., Irvine, CA (US)

(72) Inventors: Mark Bachman, Irvine, CA (US); Philip N. Duncan, Irvine, CA (US)

(21) Appl. No.: 17/834,296

(22) Filed: Jun. 7, 2022

Related U.S. Application Data
(60) Provisional application No. 63/197,914, filed on Jun. 7, 2021.

(51) Int. Cl. G06F 9/4401; G06F 9/54

(52) U.S. Cl. CPC G06F 9/4411; G06F 9/542

(57) ABSTRACT

The present invention is directed to a computing device capable of accepting, identifying, and processing signals from a plurality of different sensor types without sensor-specific code. The present invention features a small electronic device consisting of one or more sensors with a computing device that can be reconfigured for different purposes at any time, without the need for changing programming code.

### CROSS-REFERENCES TO RELATED APPLICATIONS

This application is a non-provisional and claims benefit of U.S. Provisional Application No. 63/197,914 filed Jun. 7, 2021, the specification of which is incorporated herein in its entirety by reference.

### FIELD OF THE INVENTION

The present invention is directed to a computing device capable of accepting, identifying, and processing signals from a plurality of different sensor types without sensor-specific code.

### BACKGROUND OF THE INVENTION

There is a great need to monitor conditions in an environment and convert those conditions into digital information. This need is currently driving the development of sensors, computing devices, telemetry, storage, and software in an industry trend known as the “Internet of Things” (IoT). Most monitoring systems consist of one or more sensors attached to a computing device that sends sensor data to remote computers via telemetry, such as wireless transmission to external servers (“the cloud”). The sensor data is then processed by the external computers.

Sensors generate data based on environmental conditions, but that data must typically be processed by a computer to make sense of it. In most cases, the data is sent to external computers (the cloud) via telemetry, where it is processed. In some cases, the data is processed at the site of monitoring by a small computing device connected to the sensor. The processed data can then be sent to the cloud at a later time. This approach is known as “smart edge” since the computing effort is done at the “edge”, where the physical world meets the digital world.

Computing devices that process sensor data typically need to know what sensor type they are connected to interpret the values that they read from the sensor. They then execute programming code that is written specifically for the sensor. This code can be changed at a future date, for example, if the sensor is changed. This may be done using a firmware update, by installing fresh machine-level code and using a bootloader to move the installed code into programming memory. Alternatively, some units avoid the need for firmware upgrades by running an interpreter. In this case, programming code can be uploaded and executed by the interpreter without the need for a firmware upgrade.

Both methods provide flexibility for the monitoring device because they enable the unit to be updated if the sensor is changed, or if new processing is required. However, both have serious drawbacks. A firmware upgrade is a major change to the underlying software, requiring that the system be rebooted, and is a serious security risk. Firmware upgrades are typically performed rarely and are not suitable for changing conditions often. Interpreters allow new instruction sets to be uploaded to the system without displacing all code in memory or requiring rebooting. However, interpreters place a large computing and memory burden on the device, making them unsuitable for small computing systems, such as those needed for IoT smart edge applications.

A third approach is to use a state machine in combination with a computing machine. In this configuration, the computing machine executes code, but the nature of the execution changes depending on the configuration of the state machine. Furthermore, the computing machine may execute only when certain states of the state machine are changed. A state machine and computing machine combination would allow small-sized processors to be reconfigurable and autonomous without the need for updating firmware nor for the use of resource-intensive interpreters.

### BRIEF SUMMARY OF THE INVENTION

It is an objective of the present invention to provide devices that allow for accepting, identifying, and processing sensor input from a plurality of different sensor types without requiring any sensor-specific code, as specified in the independent claims. Embodiments of the invention are given in the dependent claims. Embodiments of the present invention can be freely combined if they are not mutually exclusive.

The present invention features a computing device capable of connecting to a sensor without needing to upload new code. In some embodiments, the computing device may comprise a processor, and a memory component comprising a plurality of computer-readable instructions and a plurality of state representations. Each state representation may comprise a plurality of parameters and flow control for the plurality of computer-readable instructions. The plurality of computer-readable instructions may comprise a plurality of code blocks and steps comprising identifying a signal representing an external event from the sensor, identifying a state representation corresponding with the external event, and determining, by the state representation, which of the pre-compiled code blocks are to be executed and processing the signal through the pre-compiled code blocks and the parameters of the state representation. Executing the computer-readable instructions may not involve compilation or interpretation of new code and the memory component may contain no sensor-specific code.

This invention describes a computing device intended to be used with one or more sensors, which does not require advanced knowledge of the specific sensor type to produce meaningful data. The device can be updated at any time to allow it to operate with different sensors and under different conditions without the need for changing programming code. The device can operate autonomously, without the need for communication with outside entities. This device can be used in applications where a monitoring unit is needed, but where telemetry is difficult, and where the specific sensing needs are not known in advance.

The key element of this invention is the use of “events” which are defined by an external source and which provide information about when to begin computing operations, and how sensor data should be handled. Events are executed (“handled”) by code that is initiated by state changes (“events”), typically interrupts, such as electronic signals, timing signals, sensor values, or interrupts from the telemetry system.

Events are grouped into a “job” which provides definitions for events that the computing device will handle. Each event definition also defines how sensor data is filtered and converted into useful information. The computing device becomes an event handler and does not need to know details about the sensors or the event types in advance, allowing it to be sensor agnostic. Once the event definitions have been uploaded to the computing device, it no longer needs to have constant communication with the external source, allowing it to work autonomously. No programming code is transferred between the external source and the computing device.

The key elements of this invention are (1) a small computing device that is event-driven, (2) the device uses event definitions that are uploaded from an external source, (3) the device is agnostic to sensor types that are connected to the device, (4) device handles events when appropriate without the need for continuous connectivity to external sources, and (5) no programming code is transferred to the computing device.

One of the unique and inventive technical features of the present invention is the identification and processing of sensor input without requiring any sensor-specific code. Without wishing to limit the invention to any theory or mechanism, it is believed that the technical feature of the present invention advantageously provides for efficient processing of input from a vast quantity and variety of sensor types without requiring recompilation, reinterpretation, or uploading new code to the computing device to allow it to process specific sensor input. None of the presently known prior references or work has the unique inventive technical feature of the present invention.

Any feature or combination of features described herein is included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a high-level diagram of the invention, consisting of a small computing device that can process input from sensors, and can accept state definitions for different events from an external source in an upload called a “job”. The state conditions define one or more “events,” each of which corresponds to an event trigger. When an event trigger is recognized, the processor runs predefined code snippets using parameters provided by the event definition in the job.

FIG. 2 shows a diagram that shows how a state representation can control the logic of a pre-compiled code, to process sensor data in different ways.

FIG. 3 shows a diagram that shows how the current invention can be integrated into a standard microcontroller architecture.

FIG. 4 shows a flow chart of a method for connecting to a sensor without needing to upload new code.

### DETAILED DESCRIPTION OF THE INVENTION

Following is a list of elements corresponding to a particular element referred to herein:
101 first sensor
103 second sensor
105 connecting component
107 computing device
109 event
111 external source
201 compiled code
203 flow change
205 flow diagram
207 flow change directive
301 microcontroller firmware stack
303 E-Chip Hardware Abstract Layer
305 higher level management operations

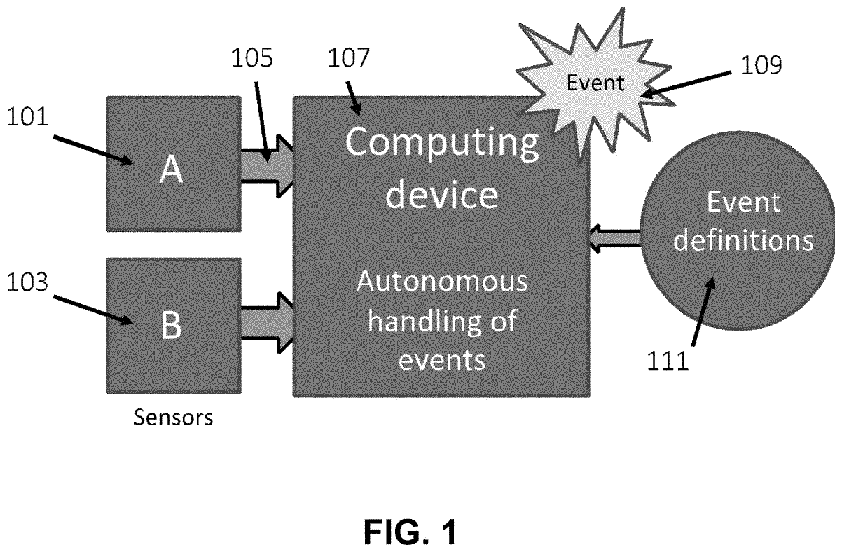

Referring now to FIG. 1, the present invention features a computing device (107) capable of connecting to a sensor (101) without needing to upload new code, either as firmware or as source code. In some embodiments, the computing device (107) may comprise a processor capable of executing computer-readable instructions. The computing device (107) may further comprise a memory component comprising a plurality of computer-readable instructions and a plurality of state representations. Each state representation may comprise a plurality of parameters and flow control for the plurality of computer-readable instructions. The plurality of computer-readable instructions may comprise a plurality of pre-compiled code blocks (201) and steps comprising identifying a signal representing an external event (109) from the sensor (101), identifying a state representation of the plurality of state representations corresponding with the external event (109), determining, by the flow control of the state representation, one or more pre-compiled code blocks (201) to be executed, and processing the signal through the one or more pre-compiled code blocks (201) and the plurality of parameters of the state representation. Executing the computer-readable instructions may not involve compilation or interpretation of new code and the memory component may contain no sensor-specific code.

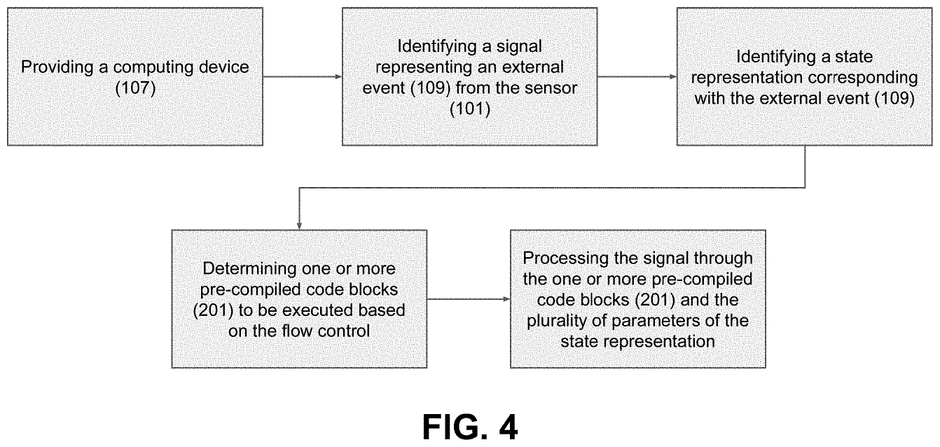

Referring now to FIG. 4, the present invention features a method for connecting to a sensor (101) without needing to upload new code. In some embodiments, the method may comprise providing a computing device (107) comprising a processor capable of executing computer-readable instructions and a memory component. The memory component may comprise a plurality of computer-readable instructions and a plurality of state representations, each state representation comprising a plurality of parameters and flow control for the plurality of computer-readable instructions. The plurality of computer-readable instructions may comprise a plurality of pre-compiled code blocks (201). The method may further comprise the computing device (107) identifying a signal representing an external event (109) from the sensor (101) and identifying a state representation of the plurality of state representations corresponding with the external event (109). The method may further comprise the flow control of the state representation determining one or more pre-compiled code blocks (201) to be executed. The method may further comprise the computing device (107) processing the signal through the one or more pre-compiled code blocks (201) and the plurality of parameters of the state representation. Executing the computer-readable instructions may not involve compilation or interpretation of new code.

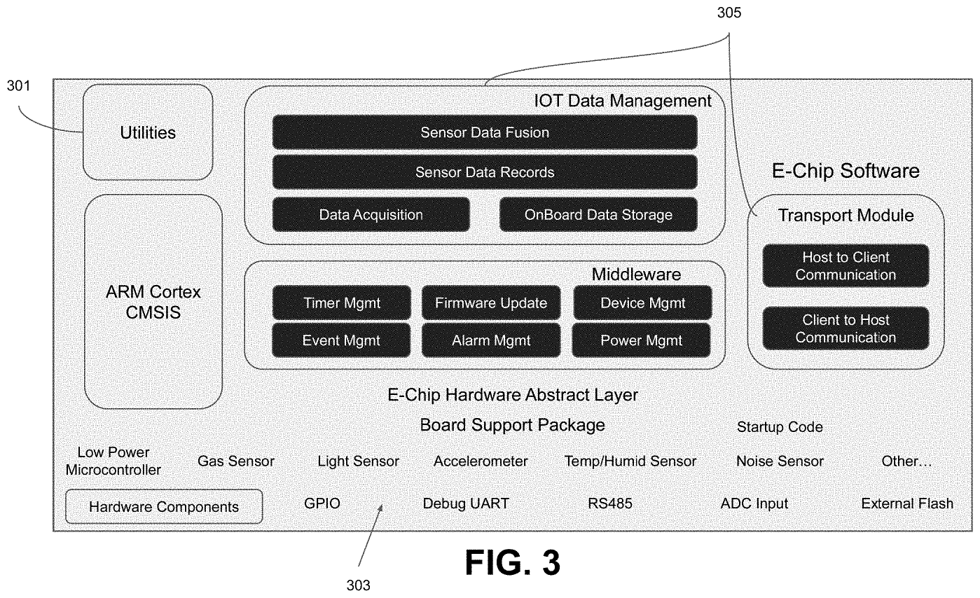

The sensor (101) implemented in the present invention may be any type of sensor, as the blocks of code, flow control, and parameters can be compatible with any sensor output. In some embodiments, the sensor (101) may comprise an analog sensor and the values of the analog sensor may be converted to digital representations through analog-to-digital converters, time-to-digital converters, or a combination thereof. In some embodiments, the plurality of computer-readable instructions and the method may further comprise steps for accepting one or more new state representations from an external source and adding the one or more new state representations to the plurality of state representations. In some embodiments, the computing device (107) may further comprise hardware components capable of identifying a signal from the sensor (101) as an external event (109). The hardware components may comprise a low power microcontroller, a gas sensor, a light sensor, an accelerometer, a temperature sensor, a humidity sensor, a startup code component, a noise sensor, general purpose input/output components, a debug universal asynchronous receiver-transmitter, an RS485 interface, an analog-to-digital conversion input component, an external memory storage component, or a combination thereof. The hardware components may be capable of identifying the external event (109) through timers, electronic levels, sensor values, telemetry interrupts, or a combination thereof. In some embodiments, as seen in FIG. 3, the computing device (107) may be integrated into a microcontroller system and act as a layer between a hardware interface (301) and a plurality of higher-level management components (305) of the microcontroller. The plurality of higher-level management components (305) may comprise sensor data fusion components, sensor data records, data acquisition components, onboard data storage components, timer management components, firmware update components, device management components, event management component, alarm management component, power management components, host-to-client communication components, client-to-host communication components, or a combination thereof.

This invention describes a computing device intended to monitor one or more conditions in an environment. The device is connected to one or more sensors that provide data on the environment. The sensors may be analog, with their values converted to digital representations using analog-to-digital converters (ADC) or time-to-digital converters (TDC), or the sensors may be digital. The computing device contains two key components: (1) a program that can be precompiled and executed to read and process the sensor inputs, and (2) one or more state representations in memory that provide parameters and flow control for the program. The computing program does not need to contain information that is specific to the sensors. The state representations can be readily changed and uploaded to non-program memory. This can be done through the use of an external set of commands and parameters, provided by an external source. This set of commands and parameters is called a “job” and defines one or more state representations. When a new job is uploaded to the device, the computing device interprets the commands and parameters to update or edit existing state representations in non-program memory. No new programming code is included in the job definitions.

FIG. 1 is an overview of the autonomous agnostic smart sensor architecture. One or more sensors (101 and 103) are connected to a computing device (105). The computing device (107) runs pre-compiled code to process the sensor data when an “event” (109) is identified. The nature of the code that is executed depends on a state representation for the event, and the calculations utilize parameters associated with the state representation. The state representation and parameters for events can be provided to the computing device from an external source at any time (111) for storage in onboard memory.

Each state representation is called an “event” and has one or more “event triggers” associated with it. Event triggers are defined by the hardware associated with the sensing unit and may result from timers, electronic levels, sensor values, telemetry interrupts, and the like. A “job” will specify what states of these hardware inputs are to be considered an event trigger and which state representation is associated with that trigger.

Once an event trigger has been identified by the computing device, it uses the state representation associated with that event trigger to guide the program to read and process the sensor values. No new programming code is compiled or interpreted, but the sequence of operations is dictated by the state representation, and the parameters used in calculations are taken from the state representation.

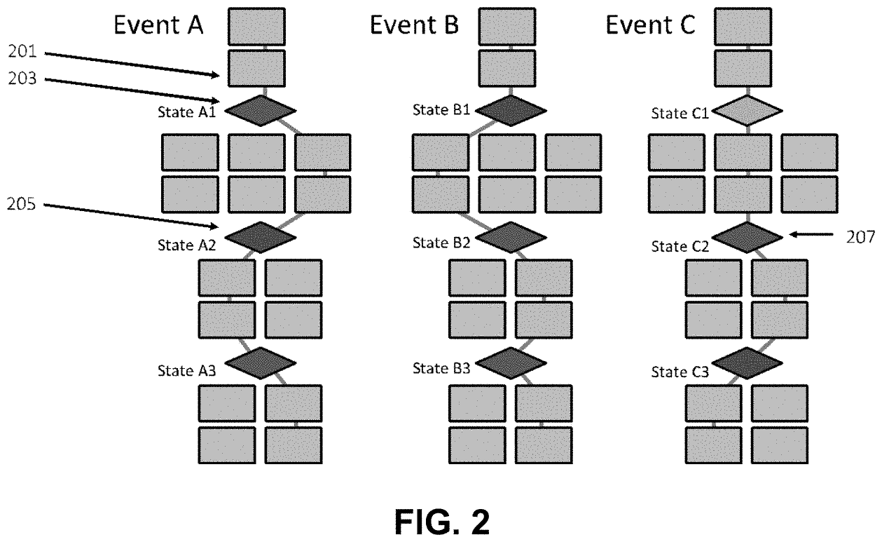

FIG. 2 shows a flow diagram for executing pre-compiled code in different ways, based on event definitions (stored as state representations). Each block (201) represents a piece of compiled code in processor memory. Each diamond (203) represents a flow change, controlling what code blocks are executed. When an event is handled, the logic flow proceeds according to one of these flow diagrams (205). A state representation in memory represents the flow change directives (207) and determines which code blocks are executed during the event processing.

FIG. 3 shows an embodiment of the current invention in a microcontroller. The microcontroller firmware stack (301) can be used to support the current invention, labeled “E-Chip Hardware Abstract Layer” (303), where the current invention sits as a layer between the hardware interface (sensor inputs) and the common higher-level management operations of the microcontroller, such as memory management and transport (305). The current invention, consisting of precompiled code that is directed by the state representation, integrates with common microcontroller architectures and allows autonomy and sensor flexibility in a small processor with good performance.

Instructions that cause at least one processing circuit to perform one or more operations are “computer-executable.” Within the scope of the present invention, “computer-readable memory,” “computer-readable storage media,” and the like comprises two distinctly different kinds of computer-readable media: physical storage media that stores computer-executable instructions and transmission media that carries computer-executable instructions. Physical storage media includes RAM and other volatile types of memory; ROM, EEPROM and other non-volatile types of memory; CD-ROM, CD-RW, DVD-ROM, DVD-RW and other optical disk storage; magnetic disk storage or other magnetic storage devices; and any other tangible medium that can store computer-executable instructions that can be accessed and processed by at least one processing circuit. Transmission media can include signals carrying computer-executable instructions over a network to be received by a general-purpose or special-purpose computer. Thus, it is emphasized that embodiments of the present invention expressly exclude signals carrying computer-executable instructions.

However, it should be understood that once a signal carrying computer-executable instructions is received by a computer, the type of computer-readable storage media transforms automatically from transmission media to physical storage media. This transformation may even occur early on in intermediate memory such as (by way of example and not limitation) a buffer in the RAM of a network interface card, regardless of whether the buffer's content is later transferred to less volatile RAM in the computer. Thus, devices that merely repeat a signal are contemplated by the embodiments of the present invention, even though the media that carry the signal between such devices and the signal itself are expressly not included within the claim scope.

Although there has been shown and described the preferred embodiment of the present invention, it will be readily apparent to those skilled in the art that modifications may be made thereto which do not exceed the scope of the appended claims.

Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A computing device (107) capable of connecting to a sensor (101) without needing to upload new code, the computing device (107) comprising:
a. a processor capable of executing computer-readable instructions; and
b. a memory component comprising a plurality of computer-readable instructions and a plurality of state representations, each state representation comprising a plurality of parameters and flow control for the plurality of computer-readable instructions, the plurality of computer-readable instructions comprising a plurality of pre-compiled code blocks (201) and steps for:
i. identifying a signal representing an external event (109) from the sensor (101);
ii. identifying a state representation of the plurality of state representations corresponding with the external event (109);
iii. determining, by the flow control of the state representation, one or more pre-compiled code blocks (201) to be executed; and
iv. processing the signal through the one or more pre-compiled code blocks (201) and the plurality of parameters of the state representation;
wherein executing the computer-readable instructions does not involve compilation or interpretation of new code.

2. The computing device (107) of claim 1, wherein the sensor (101) comprises an analog sensor.

3. The computing device (107) of claim 2, wherein the value of the analog sensor is converted to digital representations through analog-to-digital converters, time-to-digital converters, or a combination thereof.

4. The computing device (107) of claim 1, wherein the plurality of computer-readable instructions further comprises steps for:
a. accepting one or more new state representations from an external source; and
b. adding the one or more new state representations to the plurality of state representations.

5. The computing device (107) of claim 1, wherein the computing device (107) further comprises hardware components capable of identifying a signal from the sensor (101) as an external event (109).

6. The computing device (107) of claim 5, wherein the hardware components are capable of identifying the external event (109) through timers, electronic levels, sensor values, telemetry interrupts, or a combination thereof.

7. The computing device (107) of claim 1, wherein the computing device (107) is integrated into a microcontroller system and acts as a layer between a hardware interface (301) and a plurality of higher-level management components (305) of the microcontroller.

8. The computing device (107) of claim 1, wherein some sensor-specific code is included.

9. The computing device (107) of claim 1, wherein no sensor-specific code is included.

10. A method for connecting to a sensor (101) without needing to upload new code, the method comprising:
a. providing a computing device (107) comprising:
i. a processor capable of executing computer-readable instructions; and
ii. a memory component comprising a plurality of computer-readable instructions and a plurality of state representations, each state representation comprising a plurality of parameters and flow control for the plurality of computer-readable instructions, the plurality of computer-readable instructions comprising a plurality of pre-compiled code blocks (201);
b. identifying, by the computing device (107), a signal representing an external event (109) from the sensor (101);
c. identifying, by the computing device (107), a state representation of the plurality of state representations corresponding with the external event (109);
d. determining, by the flow control of the state representation, one or more pre-compiled code blocks (201) to be executed; and
e. processing, by the computing device (107), the signal through the one or more pre-compiled code blocks (201) and the plurality of parameters of the state representation;
wherein executing the computer-readable instructions does not involve compilation or interpretation of new code.

11. The method of claim 10, wherein the sensor (101) comprises an analog sensor.

12. The method of claim 11, wherein the value of the analog sensor is converted to digital representations through analog-to-digital converters, time-to-digital converters, or a combination thereof.

13. The method of claim 10 further comprising:
a. accepting one or more new state representations from an external source; and
b. adding the one or more new state representations to the plurality of state representations.

14. The method of claim 10, wherein the computing device (107) further comprises hardware components capable of identifying a signal from the sensor (101) as an external event (109).

15. The method of claim 14, wherein the hardware components are capable of identifying the external event (109) through timers, electronic levels, sensor values, telemetry interrupts, or a combination thereof.

16. The method of claim 10, wherein the computing device (107) is integrated into a microcontroller system and acts as a layer between a hardware interface (301) and a plurality of higher-level management components (305) of the microcontroller.

17. The method of claim 10, wherein some sensor-specific code is included.

18. The method of claim 10, wherein no sensor-specific code is included.
